(19) United States
(12) Patent Application Publication
(10) Pub. No.: US 2023/0249526 A1
(43) Pub. Date: Aug. 10, 2023

(54) VEHICLE SIDE STRUCTURE

(71) Applicant: TOYOTA JIDOSHA KABUSHIKI KAISHA, Toyota-shi Aichi-ken (JP)

(72) Inventors: Kazuki OHTAKE, Toyota-shi Aichi-ken (JP); Norimasa KOREISHI, Miyoshi-shi Aichi-ken (JP); Hideo TAKEDA, Hekinan-shi Aichi-ken (JP)

(73) Assignee: TOYOTA JIDOSHA KABUSHIKI KAISHA, Toyota-shi Aichi-ken (JP)

(21) Appl. No.: 18/106,011

(22) Filed: Feb. 6, 2023

(30) Foreign Application Priority Data
Feb. 9, 2022 (JP) 2022-018605

(51) Int. Cl. B60J 5/04; B62D 25/20

(52) U.S. Cl. CPC B60J 5/0479; B62D 25/20

(57) ABSTRACT

A vehicle side structure comprising a pair of rockers and a floor panel, the floor panel being provided with a through hole that penetrates the floor panel vertically, each of the pair of rockers having a inclined surface that inclines obliquely downward and outward of vehicle width direction at the outer corners of the rocker below through hole.

### CROSS REFERENCE TO RELATED APPLICATION

This application claims priority to Japanese Patent Application No. 2022-018605 filed on Feb. 9, 2022, which is incorporated herein by reference in its entirety including the specification, claims, drawings, and abstract.

### TECHNICAL FIELD

The present disclosure relates to vehicle side structures, in particular, to the structure of rockers located at both side ends of the vehicle so as to extend along vehicle longitudinal direction.

### BACKGROUND

A vehicle having a sliding door on the side, the vehicle to deploy the slope toward the outside of the vehicle has been proposed (e.g., see JP2021-008165A).

In vehicles with such sliding doors, the sliding doors are often locked to the center pillars or rear pillars of the vehicle (see, e.g., JP2015-010385A).

### SUMMARY

Incidentally, in recent years, the structure of locking the sliding door to the floor of the vehicle has been studied. In such cases, the sliding door may be equipped with a locking mechanism, and the floor panel may be equipped with a through hole that inserts a tip of the locking mechanism's hook. With this construction, foreign material may fall down from through hole and accumulate on the top surface of the rocker located below the floor panel.

The present disclosure is therefore intended to permit the discharge of foreign material dropped from a through hole provided on the floor onto the top surface of the rocker.

The vehicle side structure of the present disclosure is a vehicle side structure including a pair of rockers and a floor panel, wherein the pair of rockers are disposed on both side ends of the vehicle so as to extend along a vehicle longitudinal direction, and wherein the floor panel is disposed above the pair of rockers. The floor panel is provided with a through hole which penetrates the floor panel vertically. Then, each of the pair of rockers has a inclined surface inclined obliquely downward and outward of vehicle width direction at the outer corner of the rocker below through hole.

With this configuration, foreign material such as water or pebbles dropped from through hole to the upper surface of the rocker is discharged below and outside vehicle width direction of the rocker. This prevents foreign material dropped from through hole from staying on the top surface of the rocker.

In the vehicle side structure of the present disclosure, at least a portion of through hole and inclined surface may overlap in a vehicle top view.

This causes foreign material dropped from through hole to be ejected along inclined surface.

A vehicle-side structure of the present disclosure, comprising: a sliding door disposed above an outer end of a vehicle width direction of the floor panel and configured to slide along a vehicle longitudinal direction; and a slope device disposed below the floor panel, slope plate entering and exiting a space between a lower surface of the floor panel and an upper surface of the rocker, wherein the sliding door may comprise a locking mechanism that inserts a tip of the hook from an upper surface of the floor panel to through hole so as to lock the sliding door to the floor panel.

With this configuration, foreign material dropped from through hole to the upper surface of the rocker is discharged below and outside vehicle width direction of the rocker. In addition, it is possible to prevent foreign material from stagnating in the space between the lower surface of the floor panel and the upper surface of the locker. This prevents foreign material from stagnating in the space where slope plate enters and exits. Then, it is possible to suppress the occurrence of a problem in the entry and exit of slope plate.

In the vehicle-side structure of the present disclosure, a cover may be provided to cover inclined surface of the rocker and the space between the lower surface of the floor panel and the upper surface of the rocker from the outside of vehicle width direction.

Thus, it is possible to ensure the design of the vehicle side surface.

The disclosed vehicle-side construction allows foreign material to be ejected from the top surface of the rocker when foreign material falls from through hole on the floor panel to the top surface of the rocker.

### BRIEF DESCRIPTION OF DRAWINGS

FIG. 1 is a perspective view of a vehicle comprising a vehicle side structure of the embodiment.

FIG. 2 is a perspective view of a vehicle with the door open and slope plate deployed.

FIG. 3 is a cross-sectional view of the vehicle-side structure of the vehicle, a A-A cross-section in FIG. 1.

FIG. 4 is a partial cross-sectional perspective view showing a vehicle side structure of the vehicle shown in FIG. 1.

### DESCRIPTION OF EMBODIMENTS

Hereinafter, the vehicle-side structure 200 of the embodiment will be described with reference to the drawings. First, a vehicle 100 comprising a vehicle side structure 200 will be described. Incidentally, the arrow FR shown in the respective figures, the arrow UP, the arrow LH shows the forward direction of the vehicle 100 (traveling direction), the upward direction, the left direction, respectively. In addition, the opposite directions of the respective arrow FR, UP, LH indicate the vehicle rear direction, the downward direction, and the right direction. Hereinafter, when it is simply described using the directions of front and rear, left and right, and up and down, unless otherwise noted, it shall indicate the front and rear of vehicle longitudinal direction, the left and right directions of the vehicle (vehicle width direction), and the vertical direction of the vehicle, respectively.

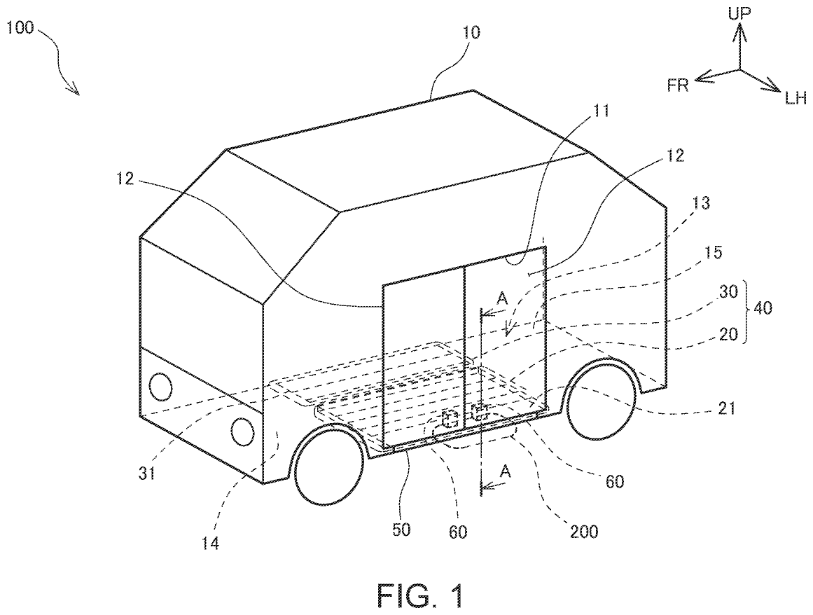

As shown in FIG. 1, the vehicle 100 includes a body 10, a door opening 11 provided on the left side surface of the body 10, and two sliding doors 12. Slide doors 12 open the door opening 11, and closes. Body 10 is provided with a floor 13 on which passengers ride. Floor 13 is composed of a front floor 14, a rear floor 15 and the central floor 40. The central floor 40 is composed of a left floor 20 on the left side of the vehicle and a right floor 30 on the right side of the vehicle. The left floor 20 is composed of a floor cross member (not shown) and a plurality of left floor panels 21 mounted above the floor cross member. Similarly, the right floor 30 is composed of a floor cross member (not shown) and a plurality of right floor panels 31 mounted above the floor cross member.

Each slide door 12 is disposed above the left end which is the outer end of vehicle width direction of the left floor panel 21. The lower end of each slide door 12, respectively locking mechanism 60 is mounted. Locking mechanism 60 locks the center portion of vehicle width direction of each sliding door 12 to the left end of the left floor panel 21. Further, below the left floor panel 21, slope device 50 is mounted.

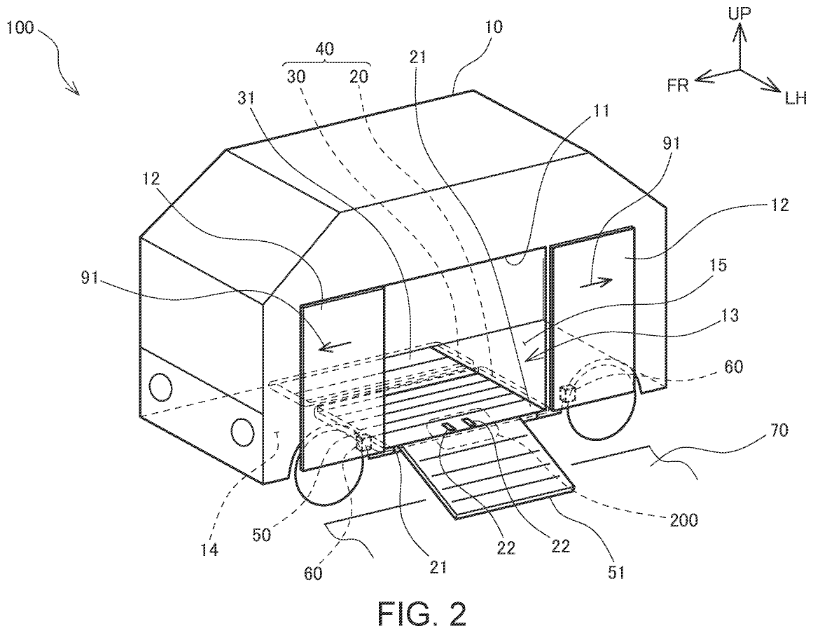

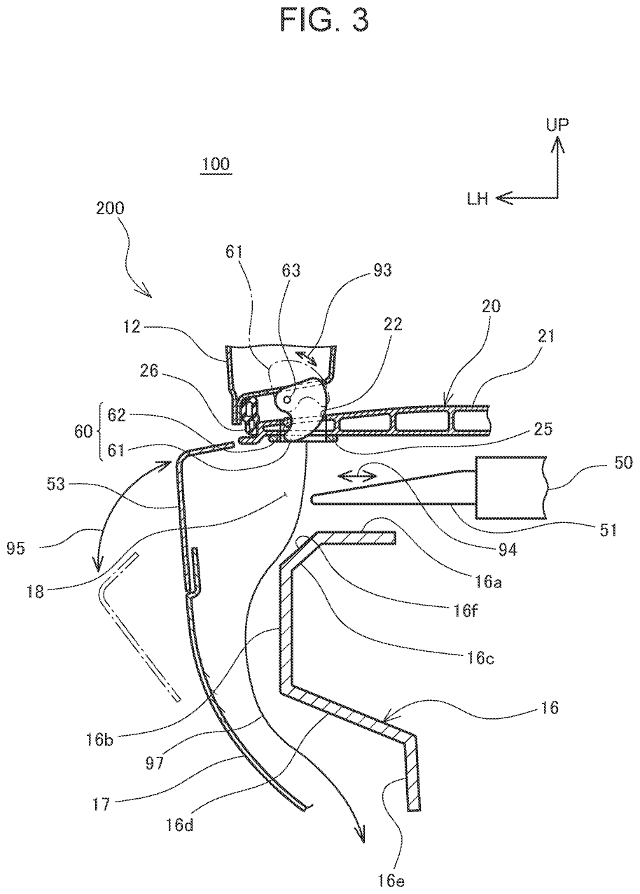

FIG. 2 shows a state in which the vehicle 100 is stopped, the slide doors 12 are opened as shown by the arrow 91. Door opening 11 appears when the slide doors 12 are opened. Further, slope plate 51 is fed out from slope device 50 when the slide doors 12 are opened so as to contact a ground surface 70. Through hole 22 is exposed at the center of vehicle longitudinal direction on the left floor panel 21. Through hole 22 penetrates the left floor panel 21 in the vehicle vertical direction. The tip of the hook 61 of the locking mechanism 60 (see FIG. 3) is inserted into through hole 22.

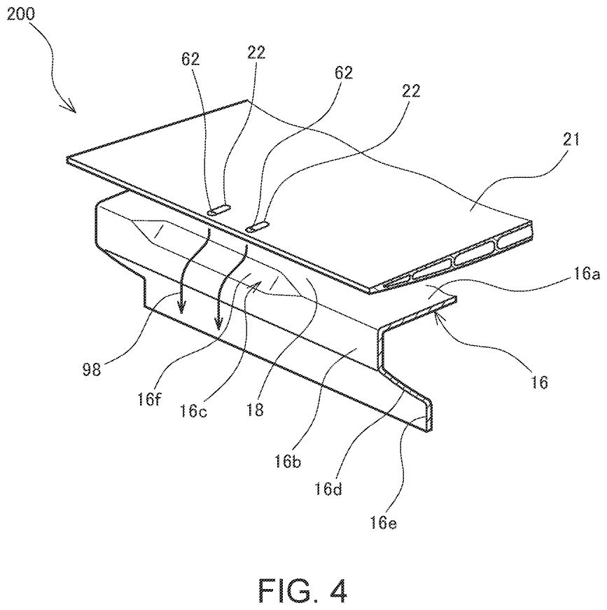

It will now be described vehicle side structure 200 with reference to FIGS. 3 and 4. As shown in FIG. 3, the vehicle-side structure 200 of the embodiment includes a locker 16, a left floor panel 21, a sliding door 12 comprising a locking mechanism 60, a slope device 50, and a cover 53.

As shown in FIG. 3, the locker 16 is a structural member of the vehicle 100 that extends to vehicle longitudinal direction and is disposed at the left end of the vehicle 100. Similarly, the locker 16 is disposed on the right end of the vehicle 100. Accordingly, the locker 16 is disposed on both side ends of the vehicle 100.

Locker 16 is a groove-shaped cross-sectional member which is open toward the inside of vehicle width direction. Locker 16 is composed of a side plate 16b, an upper flange 16a, a lower flange 16d, and a lower lip 16c. Side plate 16b is a plate member extending in vehicle longitudinal direction. The upper flange 16a is a plate member extending inward of vehicle width direction from the upper end of the side plate 16b. The lower flange 16d is a plate member extending obliquely downward from the lower end of the side plate 16b toward the inside of vehicle width direction. The lower lip 16e is a plate member extending downwardly of the vehicle from the lower end of the flange 16d. The outer part of vehicle width direction of the rocker 16 is covered from the outside of vehicle width direction with a rocker mall 17 constituting the lower design surface of the side surface of the vehicle 100.

Left floor panel 21 is disposed above the locker 16. The space 18 between the lower surface of the left floor panel 21 and the upper surface of the locker 16, slope device 50 is disposed. Slope device 50 includes a slope plate 51 and a drive (not shown). The drive deploys slope plate 51 outwardly of vehicle width direction as shown by the arrow 94 in FIG. 3. The drive also houses slope plate 51 in slope device 50. As shown in FIG. 2, slope plate 51 is deployed to the side of the vehicle 100 through a space 18 between the lower surface of the left floor panel 21 and the upper surface of the locker 16. As shown in FIG. 3, the space 18 through which slope plate 51 passes is covered from the outside of vehicle width direction with an openable cover 53. Cover 53 is attached to the rocker 16 by a linkage (not shown). As shown by a chain line in FIG. 3, when slope plate 51 is deployed, cover 53 is moved downward while rotating to expose the space 18 as shown by arrow 95. Cover 53 connects the lower end of the sliding door 12 and the rocker mole 17. Cover 53 constitutes a design surface of the vehicle side.

Locking mechanism 60 includes a hook 61 attached to the lower end of the slide door 12, and a striker 62 attached to the left floor panel 21 of the left end. Hook 61 is rotatably mounted around the rotation shaft 63 of the lower end of the slide door 12. A through hole 22 is provided on the left-hand floor panel 21. The tip of the hook 61 is inserted into through hole 22. Striker 62 is mounted on the upper side of the striker plate 25 with a convex U-shaped member thereon. The striker plate 25 is mounted on the underside of the left floor panel 21 such that the striker 62 is positioned within through hole 22.

When the slide door 12 is closed, the hook 61 is rotated in the clockwise direction as shown by the arrow 93 from the position indicated by a chain line in FIG. 3. Then, the tip enters through hole 22 from the upper surface of the left floor panel 21. Then, the tip portion is engaged with the striker 62 to lock the sliding door 12 to the left floor panel 21. Further, when the slide door 12 is closed, the seal lip 26 which is attached to the lower end of the inner slide door 12 is in contact with the left end of the left floor panel 21. Then, the seal lip 26 seals between the slide door 12 and the left floor panel 21.

As shown in FIGS. 3 and 4, the locker 16 is provided with a inclined portion 16c for connecting diagonally between the upper flange 16a and the side plate 16b. Inclined portion 16c is located below through hole 22. Here, through hole 22 is provided on the left floor panel 21 so as to penetrate in the vehicle vertical direction. Inclined portion 16c is provided at the outer corner of the rocker 16 intersecting the outer end of vehicle width direction of the upper flange 16a and the upper end of the side plate 16b. The face of inclined portion 16c constitutes an obliquely downward and outward sloping inclined surface 16f of vehicle width direction at the outer corners of the rocker below through hole 22. Further, at least a portion of inclined portion 16c is disposed so as to overlap with through hole 22 and the vehicle top view.

As shown in FIGS. 2 and 4, opening the slide door 12 exposes through hole 22 of the left floor panel 21. Through hole 22 penetrates the left floor panel 21 in the vehicle vertical direction. Therefore, foreign material such as water or pebbles from through hole 22 may fall down. On the other hand, at least a portion of inclined portion 16c of the rocker 16 is disposed so as to overlap in through hole 22 and the vehicle top view. Therefore, foreign material dropped from through hole 22, arrow 97 in FIG. 3, as shown by arrow 98 in FIG. 4, slides down obliquely downward and outward vehicle width direction along inclined surface 16f of inclined portion 16c of the rocker 16. Then, foreign material falls from inclined surface 16f toward the underside of the locker 16. Thus, it is possible to suppress foreign material dropped from through hole 22 stays on the upper surface of the rocker 16. Vehicle-side structure 200, it is possible to suppress foreign material stays in the space 18 between the lower surface of the left floor panel 21 and upper surface of locker 16. Here, the space 18 is a space in which slope plate 51 enters and exits. Therefore, the vehicle-side structure 200, it is possible to suppress the failure occurs in the deployment and storage of slope plate 51.

In the vehicle-side structure 200 of the embodiment described above, the vehicle-side structure 200 has been described as including a rocker 16, a left floor panel 21, a sliding door 12 comprising a locking mechanism 60, a slope device 50, and a cover 53, but is not limited thereto. For example, it may be composed of a rocker 16 and a left floor panel 21 having a through hole 22 penetrating vertically through the vehicle. In this instance, the locker 16 may be configured to have a inclined surface 16f that inclines obliquely downward and outward below through hole 22. Thus, it is possible to suppress foreign material dropped from through hole 22 stays on the upper surface of the rocker 16.

1. A vehicle side structure comprising a pair of rockers and a floor panel, wherein
the pair of rockers are arranged at both side end portions of a vehicle so as to extend along a vehicle longitudinal direction;
the floor panel is arranged above the pair of rocker, the floor panel having a through hole penetrating the floor panel in a vehicle vertical direction, and
each of the pair of rockers has an inclined surface that is inclined obliquely downward and outward in a vehicle width direction at an outer corner portion, in the vehicle width direction, of the rocker below the through hole.

2. The vehicle side structure according to claim 1, wherein at least a part of the through hole and the inclined surface overlap in a vehicle top view.

3. The vehicle-side structure according to claim 2, comprising:
a sliding door disposed above an outer end portion, in the vehicle width direction, of the floor panel, and configured to slide along the vehicle longitudinal direction; and
a slope device disposed below the floor panel, with a slope plate configured to enter and exit a space between a lower surface of the floor panel and an upper surface of the rocker,
wherein the sliding door includes a locking mechanism configured to insert a tip of a hook into the through hole from an upper surface of the floor panel for locking the sliding door to the floor panel.

4. The vehicle side structure according to claim 3, further comprising a cover that covers, from outside the floor panel and the rocker in the vehicle width direction, both the space between the lower surface of the floor panel and the upper surface of the rocker and the inclined surface of the rocker.
